(19) United States
(12) Patent Application Publication
(10) Pub. No.: US 2018/0083481 A1
(43) Pub. Date: Mar. 22, 2018

(54) INFORMATION PROCESSING APPARATUS AND METHOD, AND COMPUTER PROGRAM PRODUCT

(71) Applicant: Kabushiki Kaisha Toshiba, Minato-ku (JP)

(72) Inventors: Yu KANEKO, Kawasaki (JP); Yasuro SHOBATAKE, Kawasaki (JP)

(73) Assignee: Kabushiki Kaisha Toshiba, Minato-ku (JP)

(21) Appl. No.: 15/434,251

(22) Filed: Feb. 16, 2017

(30) Foreign Application Priority Data
Sep. 20, 2016 (JP) 2016-183036

(51) Int. Cl. H02J 13/00; H04L 29/08

(52) U.S. Cl. CPC H02J 13/0003; H04L 67/125

(57) ABSTRACT

According to an embodiment, in an information processing apparatus, a creation unit creates a demand-supply adjustment plan of electric power in accordance with a type of first DR request received from an upper system and creates a second DR request based on the plan. A measurement data determining unit determines measurement data of a measurement target in accordance with a type of the second DR request. A measurement interval determining unit determines a measurement interval of the measurement data in accordance with the type of second DR request. A communication protocol determining unit determines a communication protocol used for transmitting the second DR request in accordance with the type of second DR request. A first transmission unit transmits the second DR request to a lower system by using the communication protocol. A measurement unit measures the measurement data. A second transmission unit transmits the measurement data to the upper system.

### CROSS-REFERENCE TO RELATED APPLICATIONS

This application is based upon and claims the benefit of priority from Japanese Patent Application No. 2016-183036, filed on Sep. 20, 2016; the entire contents of which are incorporated herein by reference.

### FIELD

Embodiments described herein relate generally to an information processing apparatus, an information processing method, and a computer program product.

### BACKGROUND

A method for adjusting power demand called a demand response (DR) is known. In the DR, a power company transmits a DR request to consumers. The DR request includes information related to the adjustment of power demand. A consumer checks the DR request and cooperates with the power demand adjustment if possible. The power company collects amounts of power consumption from consumers to check the degree of cooperation for the power demand adjustment. Between the power company and the consumers, a company called an aggregator may be interposed.

### BRIEF DESCRIPTION OF THE DRAWINGS

FIG. 1 is a diagram that illustrates an example of the apparatus configuration of a demand adjusting system according to a first embodiment;

FIG. 2A is a diagram that illustrates an example of the functional configuration of an information processing apparatus used in an aggregator according to the first embodiment;

FIG. 2B is a diagram that illustrates an example of the functional configuration of an information processing apparatus used for an xEMS according to the first embodiment;

FIG. 3 is a diagram that illustrates an example of the functional configuration of an information processing apparatus used in a central power control center according to the first embodiment;

FIG. 4 is a flowchart that illustrates an example of a DR request receiving process according to the first embodiment;

FIG. 5 is a flowchart that illustrates an example of the processing of a normal DR and a fast DR according to the first embodiment;

FIG. 6 is a flowchart that illustrates an example of the processing of a faster DR according to the first embodiment;

FIG. 7 is a diagram that illustrates an example of the functional configuration of an information processing apparatus used in an aggregator according to a second embodiment;

FIG. 8A is a diagram that illustrates an example of a case where an access load is concentrated;

FIG. 8B is a diagram that illustrates an example of a case where the access load is distributed according to the second embodiment; and

FIG. 9 is a diagram that illustrates an example of the hardware configuration of the information processing apparatuses according to the first and second embodiments.

### DETAILED DESCRIPTION

According to an embodiment, an information processing apparatus includes a creation unit, a measurement data determining unit, a measurement interval determining unit, a communication protocol determining unit, a first transmission unit, a measurement unit, and a second transmission unit. The creation unit creates a demand-supply adjustment plan of electric power in accordance with a type of first demand response request received from an upper system and creates a second demand response request based on the demand-supply adjustment plan. The measurement data determining unit determines measurement data of a measurement target in accordance with a type of the second demand response request. The measurement interval determining unit determines a measurement interval of the measurement data in accordance with the type of second demand response request. The communication protocol determining unit determines a communication protocol used for transmitting the second demand response request in accordance with the type of the second demand response request. The first transmission unit transmits the second demand response request to a lower system by using the communication protocol. The measurement unit measures the measurement data based on the measurement data, the measurement interval, and the communication protocol. The second transmission unit transmits the measurement data to the upper system.

Various embodiments will be described below in detail with reference to the accompanying drawings.

### First Embodiment

First, the types of demand response (DR) requests used in a first embodiment will be described.

Type of DR Request

There are various methods for transmitting a DR request, and there are various methods for collecting amounts of power consumption and the like. In recent years, each of a power company (central power control center), an aggregator, and a consumer includes an energy control system that adjusts the demand and supply of power (in a case where a power supply device is not included, adjusts the demand). The energy control systems transmit a DR request and measurement data (amount of power consumption and the like) to communication destinations by communicating with each other, which is a general method.

Normal DR

Hereafter, a DR used as a plan for long-term demand-supply adjustment will be referred as a “Normal DR”. For example, a power company transmits a Normal DR request to perform a demand adjustment 24 hours later. Then, after 24 hours, consumers control their devices such as air conditioners and lightings to adjust power consumption. To create a Normal DR request, the power company predicts the weather of the day of the demand adjustment or predicts a power demand of consumers. The normal DR, for example, is issued on the previous day of the demand adjustment by the power company. Measurement data that is measured after the issuance of a normal DR, for example, is an amount of electric power (wh).

Fast DR

After the issuance of a normal DR, there are cases where the power company desires to change the content of the issued normal DR on the day of the demand adjustment. For example, there are cases where the prediction of the weather made at the time of issuing the normal DR is incorrect, and the amount of power generation using sunlight becomes smaller than an assumed amount. In such cases, the power company issues a DR request on the day on which the demand is desired to be adjusted. Hereafter, such kind of DR will be referred as a “Fast DR”. A difference between the issuance time of the Fast DR request and the start time of a target period of the demand adjustment is several hours. The fast DR, for example, is issued on the day of the demand adjustment by the power company. Measurement data that is measured after the issuance of the fast DR, for example, is an amount of electric power (wh). In other words, the measurement data that is measured after the issuance of the fast DR is similar to measurement data that is measured after the issuance of the normal DR.

Faster DR

In recent years, in accordance with implementation of high performance of each system relating to the DR, there a possibility that DR can be applied to more critical situation. For example, an ancillary service could be realized based on DR. In such cases, a difference between the issuance time of a DR request and the start time of a target period of the demand adjustment is several seconds to several minutes. Hereinafter, such kind of DR will be referred to as a “faster DR”.

Since the faster DR requires high responsiveness, the measurement data is electric power (W) instead of electric power (Wh). In addition, there is a possibility that a series of processes of issuing a DR request and checking the status of the demand adjustment performed by the consumer, which is performed by the power company, is repeated in units of several seconds to several minutes. In order to realize this process, performance improvement of each system and tight cooperation between systems are required compared to the cases of performing a normal DR or a fast DR.

Hereinafter, in a case where the normal DR, the fast DR, and the faster DR do not need to be discriminated from each other, it will be simply referred to as a DR.

Next, an example of the apparatus configuration of the demand adjusting system according to the first embodiment will be described.

“Apparatus Configuration of Demand System

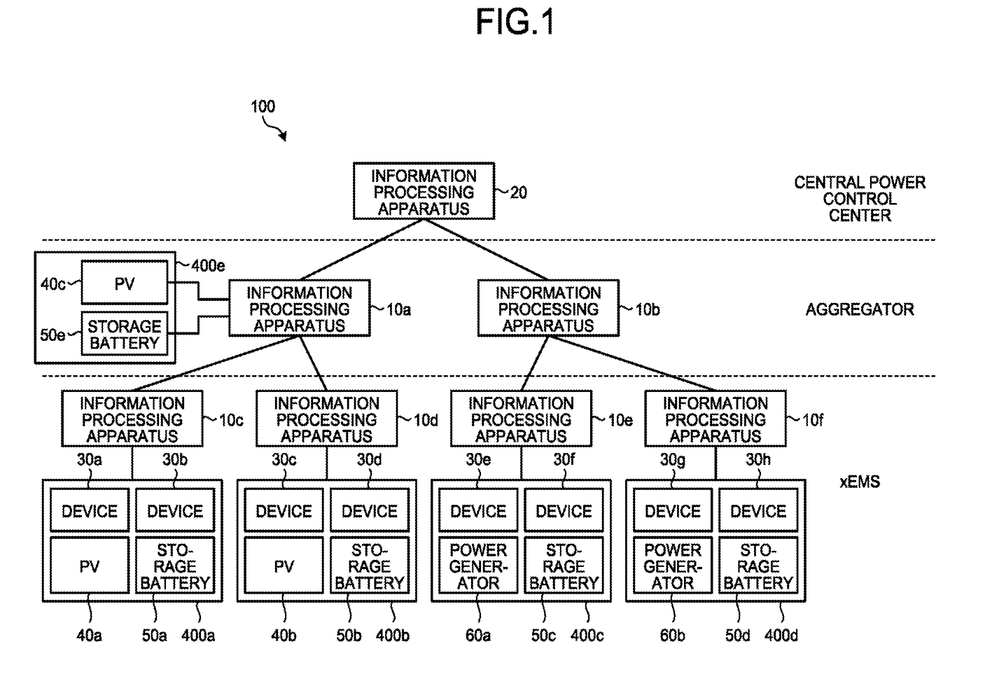

FIG. 1 is a diagram that illustrates an example of the apparatus configuration of the demand-supply adjusting system 100 according to the first embodiment. The demand-supply adjusting system 100 according to the first embodiment includes: information processing apparatuses 10a to 10f; an information processing apparatus 20; devices 30a to 30h; photovoltaic cells (PV) 40a to 40c; storage batteries 50a to 50e; and power generators 60a and 60b.

The devices 30a and 30b, the PV 40a, and the storage battery 50a are included in a control target 400a of the information processing apparatus 10c. The devices 30c and 30d, the PV 40b, and the storage battery 50b are included in a control target 400b of the information processing apparatus 10d. The devices 30e and 30f, the storage battery 50c, and the power generator 60a are included in a control target 400c of the information processing apparatus 10e. The devices 30a and 30b, the storage battery 50d, and the power generator 60b are included in a control target 400d of the information processing apparatus 10f. The PV 40c and the storage battery 50e are included in a control target 400e of the information processing apparatus 10a.

Hereinafter, in a case where the information processing apparatuses 10a to 10f do not need to be discriminated from each other, each thereof will be simply referred to as an information processing apparatus 10. Similarly, in a case where the devices 30a to 30h do not need to be discriminated from each other, each thereof will be simply referred to as a device 30. In a case where the PVs 40a to 40c do not need to be discriminated from each other, each thereof will be simply referred to as a PV 40. In a case where the storage batteries 50a to 50e do not need to be discriminated from each other, each thereof will be simply referred to as a storage battery 50. In a case where the power generators 60a and 60b do not need to be discriminated from each other, each thereof will be simply referred to as power generator 60. In addition, in a case where the control targets 400a to 400e do not need to be discriminated from each other, each thereof will be simply referred to as a control target 400.

The information processing apparatuses 10a and 10b are used by aggregators. Note that an aggregator using the information processing apparatus 10a and an aggregator using the information processing apparatus 10b may be the same aggregator or different aggregators. In description of the first embodiment, a case will be described in which the aggregator using the information processing apparatus 10a and the aggregator using the information processing apparatus 10b are different aggregators.

Each of the information processing apparatuses 10c to 10f is used by an xEMS. The xEMS is an energy control system disposed on the consumer side. The xEMS, for example, is a home energy management system (HEMS), a building energy management system (BEMS), or the like. An xEMS using the information processing apparatus 10c, an xEMS using the information processing apparatus 10d, an xEMS using the information processing apparatus 10e, and an xEMS using the information processing apparatus 10f may be the same xEMS or different xEMS's. In the description of the first embodiment, a case will be described in which the xEMS using the information processing apparatus 10c, the xEMS using the information processing apparatus 10d, the xEMS using the information processing apparatus 10e, and the xEMS using the information processing apparatus 10f are different xEMS's.

The information processing apparatus 20 is used by a central power control center.

The devices 30 are air conditioner, a lamp, and the like consuming electric power. The PV 40, the storage battery 50, and the power generator 60 are examples of power supplying devices supplying electric power. The PV 40 is a photovoltaic generation device. The storage battery 50 is a stationary storage battery. The power generator 60 is a private power generator.

The connection relations between the information processing apparatuses 10 and 20 illustrated in FIG. 1 and the control targets 400 described above are an example of a case where a normal DR or a fast DR is transmitted. For example, the information processing apparatus 10c may directly communicate with the information processing apparatus 20 not through the information processing apparatus 10a. In addition, for example, the information processing apparatus 10b may communicate with the information processing apparatus 10c.

Overview of Demand Adjusting System

Hereinafter, an overview of the operation of the demand-supply adjusting system 100 will be described with reference to FIG. 1. A system of a power company, in other words, the information processing apparatus 20 (hereinafter, referred to as a central power control apparatus) of the central power control center houses a plurality of aggregators (the information processing apparatuses 10a and 10b). The central power control apparatus creates a demand-supply adjustment plan of electric power. More specifically, the central power control apparatus creates a one-day-before demand plan predicting a power demand and creates a power generation plan (power supply plan) to supply power for the power demand.

In addition, in order to appropriately supply power generated based on the power generation plan to the xEMS (the energy control system of the consumer side), the central power control apparatus determines the topologies of a transmission system and a distribution system. An example of the energy control system of the consumer side, for example, is configured by the information processing apparatus 10c, the device 30a, the device 30b, the PV 40a, and the storage battery 30a.

Thereafter, the central power control apparatus checks, based on the power generation plan and the topologies of the transmission system and the distribution system, which have been determined, for the predicted power demand, that power supply can be performed while the voltage and the frequency are within predetermined ranges through a demand-supply simulation. This demand-supply simulation is performed for all the area to which the central power control apparatus supplies power.

In addition, when the power generation plan and the topologies of the transmission system and the distribution system described above are determined, the central power control apparatus may transmit a request for reducing the power demand of the xEMS toward the xEMS. Here, the power demand reduction request transmitted toward the xEMS at this timing will be referred to as a previous-day power demand reduction request. It needs to be attended that there is a meaning of reduction of the power demand prediction in the previous-day power demand reduction request. The normal DR described above is a DR according to the previous-day power demand reduction request, and, for example, the reduction amount is represented using the amount of electric power (Wh) or a reduction amount (%) using the amount of electric power as the base.

Thereafter, the central power control apparatus operates switchgears of the transmission system and the distribution system such that the determined topologies are formed at the start time of one day. Here, this start time is time when power supply control of one day is started, and time for example, 4 o'clock a.m.) at which the power demand is lowest in one day is selected.

On a current day on which power supply is performed, the central power control apparatus monitors the power distribution of the whole power system. For example, also in a case where a situation in which the temperature of the current day becomes higher than the assumed temperature occurs, and the actual power demand becomes higher than the predicted power demand, the central power control apparatus performs various control such that the quality (the voltage and the frequency) of supplied electric power is within a predetermined range. This control will be referred to as the current-day control.

Here, the current-day control, for example, may include increasing of the amount of power generation in a power station by starting up a power generator that is in the standby state. In addition, for example, the current-day control requests for the reduction of power demand toward the xEMS. Such a power demand reduction request is called a current-day power demand reduction request. The fast DR and the faster DR described above are DRs according to the current-day power demand reduction request. Differences between both the DRs are a difference between representation methods of the DR requests and a difference (grace period) between the issuance time and the start time of a demand adjustment period. The fast DR has the DR request represented in the amount of electric power (Wh) and is DR of which the difference is several hours. In addition, the faster DR has the DR request represented in electric power (W) and is a DR of which the difference is several minutes to several seconds.

In the current-day power demand reduction request, instead of increasing the power generation amount of the power station on the current day of the power supply, by requesting the xEMS to reduce the power demand, a total power demand is reduced to be lower than that of the power generation plan, and thus, the quality of the electric power is maintained.

In the case of the normal DR, one day before, the aggregator and the xEMS under the central power control apparatus consent to the power generation plan and the topologies of the transmission system and the distribution system of the central power control apparatus. Then, the xEMS consumes power based on the demand-supply adjustment plan set in the central power control apparatus in advance. For this reason, it can be expected with a high probability that the power demand in the demand adjustment period designated in the DR request is a power demand assumed by the central power control apparatus.

On the other hand, in the case of the fast DR or the faster DR, the central power control apparatus, the aggregator, and the xEMS do not consent to the demand-supply adjustment plan in which the fast DR or the faster DR is determined to be transmitted. For this reason, there are cases where a time of a certain degree is necessary until the power demand is actually reduced to the power demand assumed by the central power control apparatus after the fast DR or the faster DR is transmitted to the aggregator or the xEMS by the central power control apparatus.

In such cases, the central power control apparatus, until the power demand amount is reduced to a desired amount, may control for maintaining the quality of electric power by controlling power supply devices (for example, the PV 40a, the storage battery 50a, and the like) owned by the xEMS or stationary storage batteries that are arranged to be distributed in the power system. In addition, in a case where the xEMS reduces the power demand according to the request from the central power control apparatus, a certain incentive may be given from the central power control apparatus (power company) to the xEMS.

The central power control apparatus determines to transmit a normal DR, a fast DR, or a faster DR. Next, the central power control apparatus determines a power demand reduction amount requesting for each of the housed aggregators. Then, the central power control apparatus transmits a normal DR, a fast DR, or a faster DR to such aggregators for a notification of the power demand reduction amount.

The aggregator is a company that is responsible for a function for allowing easy power supply of the central power control apparatus by preventing the occurrence of a steep power demand variation by collecting the power demand of the xEMS arranged thereunder. By allowing the power company to perform easy power supply, the aggregator can purchase power at a low price from the power company. The aggregator sells power retail to individual consumers (xEMS) with a margin added to the power purchased at the low price from the power company. The aggregator houses a plurality of xEMS's.

When a normal DR, a fast DR, or a faster DR is received from the central power control apparatus, the aggregator divides a reduction amount represented in the power demand reduction request allocated to the aggregator and allocates the divided reduction amount to xEMS's arranged thereunder. Thereafter, in order to notify the allocated reduction amount to each xEMS, the aggregator transmits a normal DR, a fast DR, or a faster DR to each xEMS.

When a normal DR, a fast DR, or a faster DR is received from the aggregator, the xEMS responds to the requested power demand reduction request by controlling devices arranged thereunder. For example, in the case of the xEMS using the information processing apparatus 10c, the devices arranged thereunder are the devices 30a and 30b.

Here, in the case of a fast DR or a faster DR, similar to a case where it takes time to respond to the power demand reduction request from the central power control apparatus, there are cases where it takes time until a desired reduction amount is implemented as the xEMS responds and controls the devices arranged thereunder after the reception of a fast DR or a faster DR from the aggregator. In such a case, the aggregator may respond to a reduction amount requested according to the fast DR or the faster DR transmitted from the central power control apparatus by controlling the power supply device owned thereby or the xEMS.

When the day of the power supply ends, the central power control apparatus checks the aggregator, and the aggregator checks the xEMS whether or not the requested power demand reduction is assuredly performed. This may be performed by acquiring information relating to the amount of power consumption (Wh) per unit time that is maintained by a power meter arranged at a power reception end of the aggregator a power reception end of the xEMS.

As described above, as power demand reduction requests, there are two types including a previous-day power demand reduction request and a current-day power demand reduction request. The previous-day power demand reduction request is associated with a normal DR. The current-day power demand reduction request is associated with a fast DR and a faster DR.

In the normal DR, there is an effect of reducing a predicted power demand. Based on the predicted power demand, the power generation plan and the topologies of the transmission system and the distribution system are determined. The normal DR is a plan-based DR.

On the other hand, in the case of the fast DR or the faster DR, the central power control apparatus refers to the power generation plan and the topologies of the transmission system and the distribution system of the day of the power supply and determines whether or not a stable supply of power can be performed in consideration thereof. Then, in a case where a stable supply of power cannot be performed, the central power control apparatus transmits a fast DR or a faster DR to the aggregator. In other words, the fast DR and the faster DR are actual-demand based DRs.

A demand-supply simulation performed at the time of establishing a normal DR is performed for checking the validity (whether power can be supplied with the frequency and the voltage being within predetermined ranges) of a case where the established power supply plan is performed. The demand-supply simulation performed at the time of establishing a normal DR can be performed by taking a time longer than that of the case of a fast DR or a faster DR. In a case where the validity is not checked, the central power control apparatus can secure the validity by correcting the power generation plan and the topologies of the transmission system and the distribution system.

Accordingly, the normal DR has a characteristic of being capable of creating a DR request having high flexibility. On the other hand, in the case of a faster DR, a time that can be used for a simulation for securing the validity is short. The changing of the power generation plan and the topologies of the transmission system and the distribution system that have been already determined is performed while power is supplied, and, generally, the degree of freedom thereof is low. For this reason, the flexibility in creation of the request of a faster DR is lower than that of a normal DR.

In addition, in a fast DR, in a case where a power demand prediction of the current day of the power supply deviates from the power generation plan and the topologies of the transmission system and the distribution system established on the previous day, the power generation plan and the topologies of the transmission system and the distribution system established on the previous day are used as restriction conditions, and the reduction of the power demand of the consumer is requested so as to satisfy the restriction conditions. A period of the power demand prediction performed at the time of transmitting a fast DR is shorter than a period of the power demand prediction performed at the time of transmitting a normal DR.

In a fast DR, a time longer than that of the case of a faster DR is used for the power demand adjustment, and accordingly, control in the power demand (Wh) that is an integrated value of the power (W) can be performed, and the amount of calculation required for the execution thereof can be decreased. Meanwhile, in the fast DR, it cannot be necessarily determined that the power generation plan and the topologies of the transmission system and distribution system can be changed, and accordingly, it cannot be determined that a deviation from the prediction of the previous day of the power demand can be flexibly responded.

Next, the functional configuration of the information processing apparatus 10 used in the aggregator according to the first embodiment will be described.

Functional Configuration of Information Processing Apparatus Used in Aggregator

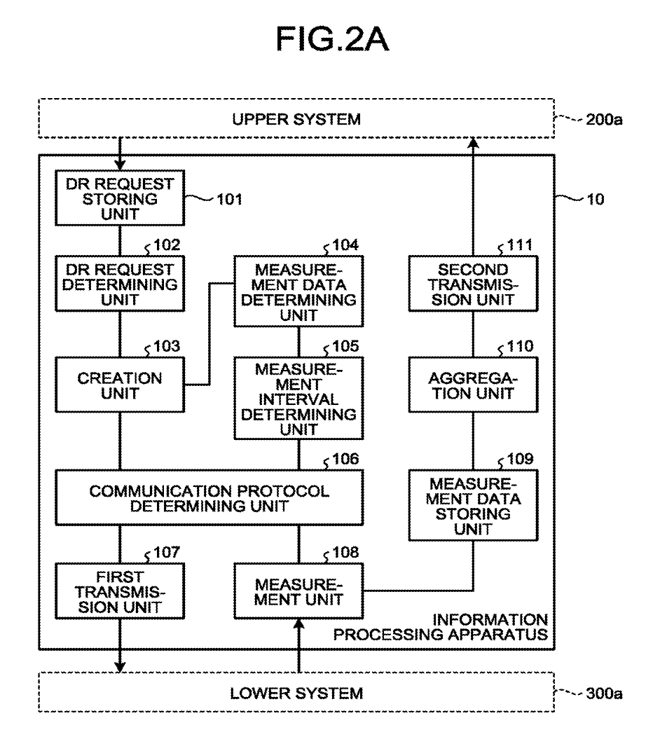

FIG. 2A is a diagram that illustrates an example of the functional configuration of the information processing apparatus 10 used in the aggregator according to the first embodiment. The information processing apparatus 10 according to the first embodiment includes: a DR request storing unit 101; a DR request determining unit 102; a creation unit 103; a measurement data determining unit 104; a measurement interval determining unit 105; a communication protocol determining unit 106; a first transmission unit 107; a measurement unit 108; a measurement data storing unit 109; an aggregation unit 110; and a second transmission unit 111.

Upper System

In the case of the information processing apparatuses 10a and 10b used in the aggregator, an upper system 200a is the information processing apparatus 20 used in the central power control center.

Lower System

In the case of the information processing apparatus 10a used in the aggregator, a lower system 300a is the information processing apparatuses 10c and 10d used in the xEMS. In the case of the information processing apparatus 10b used in the aggregator, the lower system 300a is the information processing apparatuses lee and 10f used in the xEMS.

While the information processing apparatus 10a used in the aggregator is directly communicable with the control target 400e (the PV 40c and the storage battery 50e), the configuration is not necessarily required and is not illustrated in FIG. 2A.

Description of Each Function

The DR request storing unit 101 stores a DR request instructed from the upper system 200a. The DR request, for example, includes information of (1) to (4) described below.

(1) Target Period of Demand Adjustment (DR Period)

(2) Electricity Charge in DR Period

(3) Amount of Reduction of Power Demand in DR Period

(4) Baseline (Threshold) of Power Consumption in DR Period

A DR period is defined from a start time of a period in which the power demand is adjusted to an end time. Here, between the start time and the end time, a plurality of intervals may be included.

In addition, electricity charge and the reduction amount are designated for each interval. For example, in a case where the DR period is two hours, and the interval is 30 minutes, four electricity charges and four reduction amounts are designated.

The baseline represents an upper limit of the power consumption in the DR period.

The DR request determining unit 102 determines a type (a normal DR, a fast DR, or a faster DR) of a DR request received from the upper system 200a. In a case where, in a DR request, information directly representing the type of the DR request is not included, the DR request determining unit 102 determines the type of the DR request based on information included in the DR request.

Example of Determination of DR Request

(1) For example, in a case where the start of a DR period included in the DR request is a next day or later, the DR request determining unit 102 determines that the DR request is a normal DR.

(2) For example, in a case where the start time of a DR period included in the DR request is time on the current day, the DR request determining unit 102 determines that the DR request is a fast DR or a faster DR.

(3) For example, in a case where the interval of the electricity charge and the reduction amount included in a DR request is several seconds to several tens of seconds, the DR request determining unit 102 determines that the DR request is a faster DR.

(4) For example, in a case where a difference between time when a DR request is received from the upper system 200a and start time of the DR period included in the DR request is several seconds to several minutes, the DR request determining unit 102 determines that the DR request is a faster DR.

(5) For example, in a case where the start time of the DR period included in a DR request is the current day, but the conditions of (3) and (4) are not satisfied, the DR request determining unit 102 determines that the DR request is a fast DR.

The creation unit 103, the measurement data determining unit 104, and the measurement interval determining unit 105 operate according to the type of DR request. In a case where the DR request is a normal DR or a fast DR, a demand-supply adjustment using the amount of electric power (Wh) as the base is performed. For this reason, the operations of the creation unit 103, the measurement data determining unit 104, and the measurement interval determining unit 105 of a case where the DR request is a normal DR and the operations of the creation unit 103, the measurement data determining unit 104, and the measurement interval determining unit 105 of a case where the DR request is a fast DR are similar to each other.

On the other hand, in a case where the DR request is a faster DR, a demand-supply adjustment using the electric power (W) as the base performed. For this reason, the operations of the creation unit 103, the measurement data determining unit 104, and the measurement interval determining unit 105 of a case where the DR request is a faster DR and the operations of the creation unit 103, the measurement data determining unit 104, and the measurement interval determining unit 105 of a case where the DR request is a normal DR or a fast DR are different from each other.

The creation unit 103 performs a demand-supply simulation based on the DR request received from the upper system 200a and the measurement data of the lower system 300a stored in the measurement data storing unit 109, thereby creating a demand-supply adjustment plan of electric power. In addition, the creation unit 103 may create a demand-supply adjustment plan of electric power by referring to a result of the demand-supply simulation performed in advance. In addition, there are also cases where the creation unit 103 determines that the original DR request cannot be responded. In addition, the creation unit 103 may create a demand-supply adjustment plan without using the measurement data of the lower system 300a stored in the measurement data storing unit 109.

In addition, the creation unit 103, based on the demand-supply adjustment plan, creates a DR request for the lower system 300a or a control command for the control targets 400. Examples of the control command include a control command for cutting off power of the device 30 (for example, an air conditioner or the like) and a control command for discharging the storage battery 50.

In a case where the type of DR request is a normal DR, the creation unit 103, based on a one-day before prediction of a power demand, controls the control targets 400 between a designated DR start time to an end time and creates a demand-supply adjustment plan of electric power used in the xEMS.

In a case where the type of DR request is a normal DR, the collection of a power generation plan, the topology of the transmission/distribution system, and physical quantities used at the time of performing a simulation used for verifying the validity of a power demand reduction request may be performed by taking a relatively long time. The creation unit 103 performs a demand-supply simulation at the time of establishing a demand-supply adjustment plan of the previous day based on the power demand prediction. The physical quantities used at the time of performing a demand-supply simulation, for example, are a power demand record of the previous day used for correcting a power demand prediction of the next day and a voltage, a frequency, and the like in the power demand record of the previous day.

The collection of the physical quantities is performed regardless whether or not a DR request is transmitted. The collection of the physical quantities may not be performed through a communication network. As an extreme case, it may be configured such that actual measured data of each power distribution station is recorded on an attachable/detachable storage medium such as a magnetic tape, and the actual data is read by the central power control apparatus from the storage medium and is reflected on a simulation.

In addition, in a case where the type of DR request is a fast DR, by using the power generation plan assumed in the simulation performed on the previous day as restriction conditions, an operation for adjusting the power demand to the power generation plan is performed, and accordingly, it is not necessary to transmit information required for detailed demand-supply simulation to the central power control apparatus.

In contrast to this, in the case of a faster DR requiring verification of the validity of a power demand reduction request in a short time, the creation unit 103 needs to draft a demand-supply adjustment plan while referring to not only the amount of electric power, which is an integrated value of the power consumption but also the voltage, the frequency, and the electric power and perform a demand-supply simulation for checking that the demand-supply adjustment plan is valid. Alternatively, the creation unit 103 performs demand-supply simulations for several possible power supply predictions in advance and checks whether such power demand predictions coincide with a pattern of the calculated power supply and, in the case of no coincidence, adds a current-day power demand reduction request for the coincidence thereof. For this reason, in a case where the type of DR request is a faster DR, the physical quantities that are necessary for such a demand-supply simulation need to be accessible from the information processing apparatus 10 at a necessary frequency.

The measurement data determining unit 104 determines measurement data in accordance with the type of DR request. The measurement data of the case of a normal DR or a fast DR is different from the measurement data of a case where the type of DR request is a faster DR.

Example of Measurement Data of Normal DR

Power Consumption of the Whole Lower System 300a

In a case where the execution of a power reduction requested from the upper system 200a is notified to the upper system 200a after the end of the power supply of the current day, the power consumption of the whole lower system 300a is transmitted by the second transmission unit 111. In addition, the power consumption of the whole lower system 300a is used by the creation unit 103 so as to check whether a power reduction request requested to the lower system 300a is executed during the power supply of the current day.

Example of Measurement Data of Fast DR

Power Consumption of the Whole Lower System 300a

Power Consumption for Each of the Control Targets 400 (the Device 30 and the Like) of the Lower System 300a

Information other than the power consumption, for example, the amount of power generation of the PV 40, the chargeable/dischargeable power of the storage battery 50, and the operation state of each device 30

Example of Measurement Data of Faster DR

Measurement Data Relating to the Voltage (V), the Frequency (Hz), and the Electric Power (W)

In a case where the type of DR request is a faster DR, more detailed measurement data is required. The reason for this is that, in the case of a faster DR, in order to achieve a demand adjustment at high accuracy in a speedy manner, the creation unit 103, after considering the power consumption, the amounts of power generation, the operation states, and the like in the device level, needs to quickly correct the supply/demand adjustment plan.

In addition, while a policy for constantly measuring detailed measurement data in consideration of a faster DR nay be considered, it is difficult to perform such a policy for the following reasons.

(1) Increase in the communication charge due to an increase in the amount of communication (2) Increase in the invested cost of the system due to an increase in the total amount of the load for the system

The measurement interval determining unit 105 determines a measurement interval of the measurement data in accordance with the type of DR request. The measurement interval determining unit 105 determines the measurement interval of the measurement data to be the same as the interval of the DR period included in the DR request received from the upper system 200a or an interval shorter than the interval described above. The measurement interval determining unit 105, for example, in a case where the interval of the DR request is 30 minutes, determines the measurement interval to be 15 minutes, 30 minutes, or the like. The reason for this is that the creation (correction) of the demand adjustment plan and the calculation of the effect of the demand adjustment cannot be accurately performed unless the measurement unit 108 measures the data at an interval that is the interval of the DR request or less.

The communication protocol determining unit 106 determines the physical quantities described above and a communication protocol used for an instruction (transmission of a DR request) of the demand adjustment in accordance with the type of DR request. More specifically, the communication protocol determining unit 106 determines a communication protocol based on the measurement interval of the measurement data determined in accordance with the type of DR request, the measurement data that is the measurement target, and the like.

In a case where the type of DR request is a normal DR or a fast DR, the communication protocol determining unit 106 determines the communication protocol for transmitting the DR request and a control command, for example, as OpenADR.

On the other hand, in a case where the type of DR request is a faster DR, the communication protocol determining unit 106 determines a communication protocol for transmitting a control command used for controlling the storage battery 50, for example, to be IEC 61850. In addition, in a case where the type of DR request is a faster DR, the communication protocol determining unit 106 determines a communication protocol for receiving the physical quantities described above, for example, to be IEC 61968 or the like.

The reason for changing the communication protocol based on the measurement interval of data is that there are cases where, depending on a communication protocol, it takes a time for the communication in accordance with the specification thereof. A communication protocol requiring a time cannot satisfy the time restriction of the faster DR and thus, cannot be used in the case of the faster DR. For example, a communication protocol designed in consideration of real-time control in a form in which, like IEC 61850, the upper limit of the length of a control parameter name is set, can further shorten a time required for the communication than a communication protocol in which flexible structure data is directly used like the XML.

In addition, the reason for changing the communication protocol based on the measurement data of a measurement target is that, depending on the communication protocol, the types of data that can be handled (transmitted) are limited. In the case of a faster DR, the measurement data is different from that of the case of a normal DR or a fast DR, and accordingly, the communication protocol determining unit 106 determines a communication protocol different from that of the case of a normal DR or a fast DR.

Here, the communication protocol used for the transmission of a DR request and the communication protocol used for the transmission of the above-described physical quantities transmitted from the lower system 300a to the information processing apparatus 10 may be different from each other.

The first transmission unit 107 transmits a DR request or a control command created by the creation unit 103 to the lower system 300a by using the communication protocol determined by the communication protocol determining unit 106.

The measurement unit 108 measures the above-described physical quantities transmitted from the lower system 300a to the information processing apparatus 10 based on the measurement data determined by the measurement data determining unit 104, the measurement interval determined by the measurement interval determining unit 105, and the communication protocol determined by the communication protocol determining unit 106, thereby acquiring the measurement data.

The measurement data storing unit 109 stores the measurement data acquired using the measurement unit 108. The measurement data is transmitted to the upper system 200a, for example, by using the second transmission unit 111. In addition, for example, the measurement data is used for the creation of the demand-supply adjustment plan using the creation unit 103.

The aggregation unit 110 determines whether or not the measurement data is to be aggregated and, in a case where the measurement data is to be aggregated, aggregates the measurement data. Here, the aggregation of the measurement data represents calculation of aggregated values such as a sum value of the measurement data and an average value of the measurement data or compression of the measurement data.

In a case where the type of DR request is a normal DR, there are cases where the aggregated values of the measurement data are sufficient as data used for creating (verifying) a demand-supply adjustment plan of electric power. In such cases, as the aggregation unit 110 aggregates the measurement data into the aggregated values in the information processing apparatus 10, the amount of communication between the information processing apparatus 10 and the upper system 200a can be reduced. In addition, by aggregating the measurement data into aggregated values by using the information processing apparatus 10, the process of aggregating the measurement data using the upper system 200a can be omitted.

In a case where the aggregation unit 110 aggregates the measurement data, a processing time for calculating the aggregated values is necessary. Accordingly, a time required for the transmission for the upper system 200a is longer than that of a case where the measurement data is transmitted as it is.

On the other hand, in a case where the type of DR request is a faster DR, the aggregation unit 110 does not aggregate the measurement data. The reason for this is as follows.

(1) There are cases where detailed measurement data for each device 30 is necessary.

It is necessary to shorten time as much as possible until the measurement data arrives at the upper system 200a.

(3) The aggregation of the measurement data can be performed also in the upper system 200a as is necessary.

In addition, in a case where the measurement data is compressed by the aggregation unit 110, there are cases where the amount of communication between the information processing apparatus 10 and the upper system 200a is decreased as the second transmission unit 111 transmits the compressed measurement data to the upper system 200a. Accordingly, there are cases where a communication charge and a communication time between the information processing apparatus 10 and the upper system 200a are decreased.

In a case where the type of DR request is a faster DR, it is of significance to decrease a communication time between the information processing apparatus 10 and the upper system 200a. In a case where the effect of shortening the communication time is above the processing time for compressing the measurement data, the aggregation unit 110 compresses the measurement data.

The aggregation unit 110 aggregates the measurement data when a grace period until a demand adjustment of electric power during a period designated by a first DR request is started after the transmission of the DR request is equal to or longer than a threshold (first threshold), and a time until the measurement data arrives at the upper system 200a from the information processing apparatus 10 is shorter in a case where the measurement data is aggregated than in a case where the measurement data is not aggregated.

The second transmission unit 111 transmits the measurement data or the aggregated measurement data to the upper system 200a.

Next, the functional configuration of the information processing apparatus 10 used in the xEMS according to the first embodiment will be described.

Functional Configuration of Information Processing Apparatus Used in xEMS

FIG. 2B is a diagram that illustrates an example of the functional configuration of the information processing apparatus 10 used for the xEMS according to the first embodiment. The information processing apparatus 10 according to the first embodiment includes: a DR request storing unit 101; a DR request determining unit 102; a creation unit 103; a measurement data determining unit 104; a measurement interval determining unit 105; a communication protocol determining unit 106; a first transmission unit 107; a measurement unit 106; a measurement data storing unit 109; an aggregation unit 110; and a second transmission unit 111.

The functional configuration of the information processing apparatus 10 used in the xEMS is similar to the functional configuration (see FIG. 2A) of the information processing apparatus 10 used in the aggregator, and thus, parts different from the description presented above with reference to FIG. 2A will be described.

Upper System

In the case of the information processing apparatuses 10c and 10d used in the xEMS, a upper system 200b is the information processing apparatus 10a used in the aggregator and the information processing apparatus 20 used in the central power control center. In addition, in the case of the information processing apparatuses 10e and 10f used in the xEMS, an upper system 200b is the information processing apparatus 10b used in the aggregator and the information processing apparatus 20 used in the central power control center.

Control Target

The information processing apparatus 10 used in the xEMS communicates with control targets 400. For example, the information processing apparatus 10c used in the xEMS communicates with control target 400a (the devices 30a and 30b, the PV 40a, and the storage battery 50a).

Example of Control

In a case where the type of DR request is a normal DR, the creation unit 103 creates a control command for controlling the demand-supply adjustment plan of the electric power of the xEMS and the electric power of the control targets 400 between a designated DR start time to an end time based on the one-day-before prediction of the power demand.

In a case where the type of DR request is a normal DR or a fast DR, as a method of controlling the device 30, for example, control (for example, control for raising the set temperature of an air conditioner in a summer season) for slowing the change in the power demand may be used.

On the other hand, in a case where the type of DR request is a faster DR, the creation unit 103 creates a demand-supply adjustment plan of electric power on the premise of control performed such that a period until measurement data used for checking the power demand is acquired after the transmission of the DR request is several seconds to several minutes.

In a case where the type of DR request is a faster DR, as a method of controlling the device 30 (for example, an air conditioner, a lamp, or the like), for example, control lowering the power source can be used. In addition, for example, as a method of controlling the storage battery 50, control discharging the storage battery 50 can be used.

In addition, in a case where the type of DR request is a fast DR, since the period until the measurement data used for checking the power demand is acquired after the transmission of the DR request is shorter than that of the case of a normal DR or a fast DR, and thus, the creation unit 103 selects a control target 400 having a required response performance and creates a control command.

Transmission Destination of Measurement Data

In a case where the type of DR request is a normal DR or a fast DR, for the second transmission unit 111, the transmission destination of the measurement data is the information processing apparatus 10 used in the aggregator. When measurement data is received from the information processing apparatus 10 used in the xEMS, the information processing apparatus 10 used in the aggregator transmits the measurement data to the information processing apparatus 20 used in the central power control center. The transmitted measurement data may be aggregated into an aggregated value by the aggregation unit 110. By aggregating the measurement data into the aggregated value, simplification of the demand adjustment plan and a reduction in the processing amount can be expected.

On the other hand, in a case where the type of DR request is a faster DR, it is necessary for the second transmission unit 111 to transmit the measurement data to the upper system 200b in several seconds to several tens of seconds. In addition, the information processing apparatus 10 used in the xEMS needs to receive a feedback of the demand adjustment from the upper system 200b by receiving a DR request again from the upper system 200b.

For this reason, in a case where the type of DR request is a faster DR, the second transmission unit 111 transmits the measurement data to all the upper systems 200b arranged at a rank upper than the own apparatus. For example, in the case of the information processing apparatus 10c used in the xEMS, the measurement data is directly transmitted to the information processing apparatus 10a used in the aggregator and the information processing apparatus 20 used in the central power control center. In this way, a time until the measurement data is transmitted from the information processing apparatus 10 used in the xEMS to the information processing apparatus 20 used in the central power control center is shortened.

In a case where the grace period until a demand adjustment of the electric power during a period designated by the DR request is started is a threshold (second threshold) or less, the second transmission unit 111 transmits the measurement data to a transmission source of the DR request not through another information processing apparatus 10.

The upper system 200b creates a next demand-supply adjustment plan by using the measurement data received from the information processing apparatus 10.

Next, the functional configuration of the information processing apparatus 20 used in the central power control center according to the first embodiment will be described.

Functional Configuration of Information Processing Apparatus Used in Central Power Control Center

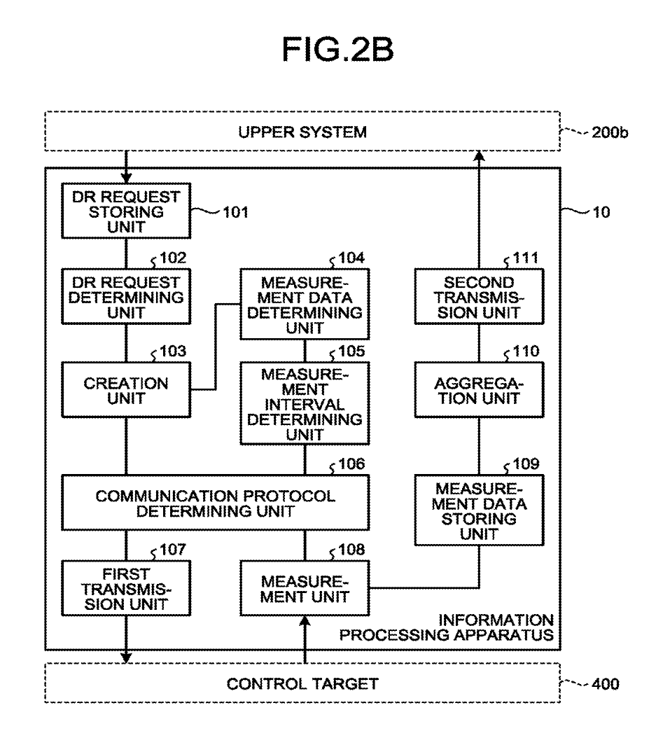

FIG. 3 is a diagram that illustrates an example of the functional configuration of the information processing apparatus 20 used in the central power control center according to the first embodiment. The information processing apparatus 20 according to the first embodiment includes: a creation unit 103; a measurement data determining unit 104; a measurement interval determining unit 105; a communication protocol determining unit 106; a first transmission unit 107; a measurement unit 108; and a measurement data storing unit 109.

There is no upper system of the information processing apparatus 20 used in the central power control center. For this reason, in the information processing apparatus 20 according to the first embodiment, the DR request storing unit 101, the DR request determining unit 102, the aggregation unit 110, and the second transmission unit 111 are not present, which is different from the functional configuration of the information processing apparatus 10 according to the first embodiment.

Lower System

The lower system 300b is configured as the information processing apparatuses 10a and 10b used in the aggregator and the information processing apparatuses 10c to 10f used in the xEMS.

The functional configuration of the information processing apparatus 20 used in the central power control center is similar to the functional configuration (see FIG. 2A) of the information processing apparatus 10 used in the aggregator, and thus, the description thereof will not be presented.

Supplement of Supply/Demand Simulation

Next, the demand-supply simulation performed by the creation unit 103 of the information processing apparatus 10 (20) will be supplemented.

In order to rotate the faster DR at the cycle of a period of several seconds, the information processing apparatus 10 (20) changes the measurement data to be handled. In order to implement a faster DR, the information processing apparatus 10 (20) not only controls the control targets 400 such that the amount of electric power (Wh) does not exceed the required upper limit but also controls the power consumption (W) in detail based on the generated power and the power consumption (W) of the control target 400 at that time point and the actual measured values of the voltage and the frequency of the supplied electric power. In this way, the information processing apparatus 10 (20) assures that the voltage, the frequency, and the like of the supplied electric power are within predetermined ranges.

While the creation unit 103 of the information processing apparatus 20 used in the central power control center predicts the operation of the power system through the demand-supply simulation, the amount of the calculation of the simulation is large, and it is unreasonable to perform the demand-supply simulation in a time (for example, one second) required for performing a fast DR for the entire area (for example, the whole district of Kanto) of the power system to which a power company supplies electric power.

For this reason, instead, the creation unit 103 of the information processing apparatus 10 used in the aggregator performs the demand-supply simulation with the target range limited to an area (for example, Kawasaki Ward, Kawasaki City) for which the power service is provided, whereby the amount of calculation is decreased.

Instead of providing the power service for a limited area, a case may be considered in which an aggregator provides the power service for a base group that is regionally distributed but belongs to the same body (for example, Minato Ward, Tokyo, Kawasaki Ward, Kawasaki City, Saiwai Ward, Kawasaki City, and the like). Also in such a case, similarly, the information processing apparatus 10 used in the aggregator performs the demand-supply simulation not for the entire area of the power system but for such a base group and the periphery thereof, whereby the amount of calculation is small.

Next, an information processing method according to the first embodiment will be described.

Information Processing Method

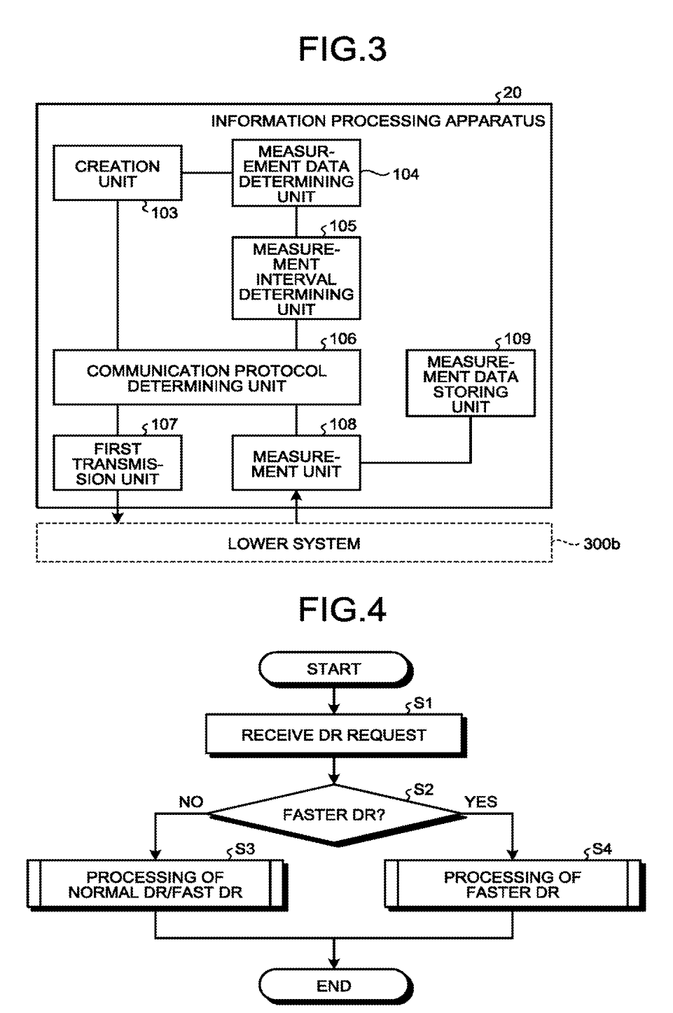

Hereinafter, an information processing method according to the first embodiment will be described for the case of the information processing apparatus 10 used in the aggregator as an example with reference to FIGS. 4 to 6.

Receiving Process

FIG. 4 is a flowchart that illustrates an example of a DR request receiving process according to the first embodiment. First, the DR request storing unit 101 stores a DR request received from the upper system 200a (step S1). Next, the DR request determining unit 102 determines whether or not the type of the DR request is a faster DR (step S2).

In a case where the type of the DR request is not a faster DR (step S2: No), in other words, in a case where the type of the DR request is a normal DR or a fast DR, a first processing for processing a normal DR and a fast DR is performed (step S3).

On the other hand, in a case where the type of the DR request is a faster DR (step S2: Yes), a second processing for processing a faster DR is performed (step S4).

First Processing

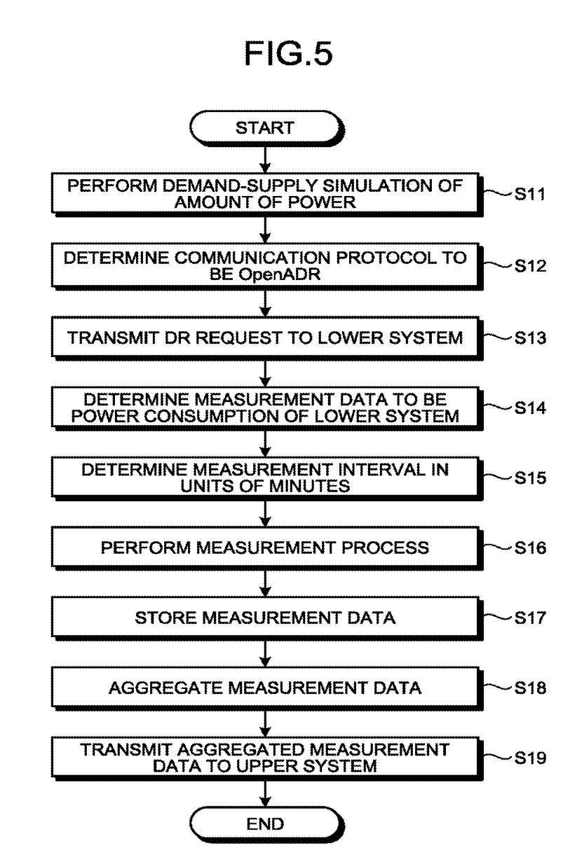

FIG. 5 is a flowchart that illustrates an example of the processing of a normal DR and a fast DR according to the first embodiment. First, the creation unit 103 creates a demand-supply adjustment plan of electric power based on an amount of electric power (wh)-based demand-supply simulation (step S11). Next, the communication protocol determining unit 106 determines the communication protocol, for example, to be OpenADR (step S12).

Next, the first transmission unit 107 transmits a DR request (a normal DR or a fast DR) or a control command based on the demand-supply adjustment plan created at step S11 to the lower system 300a by using the communication protocol determined at step S12 (step S13).

Next, the measurement data determining unit 104 determines measurement data to be the power consumption of the lower system 300a (step S14). Next, the measurement interval determining unit 105 determines a measurement interval of the measurement data determined at step S14 in units of minutes (for example, in units of ten minutes) (step S15). Next, the measurement unit 108 performs a measurement process based on the communication protocol determined at step S12, the measurement data determined at step S14, and the measurement interval determined at step S15 (step S16).

Next, the measurement data storing unit 109 stores the measurement data acquired at step S16 (step S17). Next, the aggregation unit 110 aggregates the measurement data stored at step S17, for example, into a sum value or the like (step S18). Next, the second transmission unit 111 transmits the measurement data aggregated at step S16 to the upper system 200a (step S19).

Second Processing

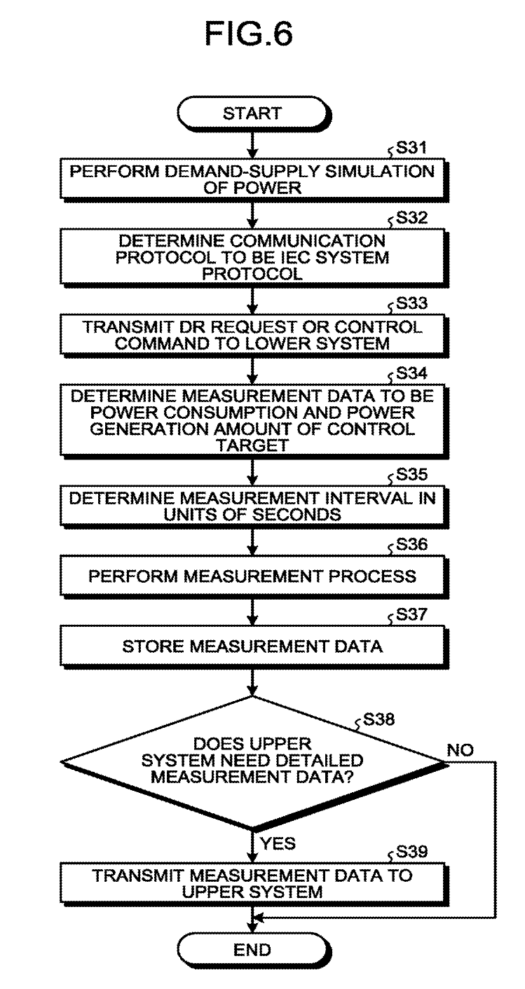

FIG. 6 is a flowchart that illustrates an example of the processing of a faster DR according to the first embodiment.

First, the creation unit 103 creates a demand-supply adjustment plan of electric power based on a power (w)-based demand-supply simulation (step S31). More specifically, the creation unit 103 creates a demand-supply adjustment plan of electric power based on a DR request received from the upper system 200a and measurement data of the lower system 300a stored in the measurement data storing unit 109.

In addition, the creation unit 103 may create a demand-supply adjustment plan of electric power without using the measurement data of the lower system 300a. The measurement data of the lower system 300a, for example, is used for a case where it is checked whether or not a power demand reduction request according to a faster DR created according to the demand adjustment plan of electric power is valid or the like.

Next, the communication protocol determining unit 106 determines the communication protocol, for example, to be an IEC system protocol (step S32). More specifically, for example, in a case where the control targets 400 are controlled in real time, the communication protocol determining unit 106 determines the communication protocol to be IEC 61850. In addition, for example, in a case where detailed states of the control targets 400 are acquired, the communication protocol determining unit 106 determines the communication protocol to be IEC 61968.

Next, the first transmission unit 107 transmits a DR request (faster DR) or a control command based on the demand-supply adjustment plan created at step S31 to the lower system 300a by using the communication protocol determined at step S32 (step S33).

Next, the measurement data determining unit 104 determines the measurement data to be the power consumption of the devices 30 included in the control targets 400 and the power generation amounts of the power supplying devices (for example, the PV 40 and the like) included in the control targets 400 (step S34).

Next, the measurement interval determining unit 105 determines the measurement interval of the measurement data determined at step S34 in units of seconds (for example, in units of ten seconds) (step S35).

Next, the measurement unit 108 performs a measurement process based on the communication protocol determined at step S32, the measurement data determined at step S34, and the measurement interval determined at step S35 (step S36).

Next, the measurement data storing unit 109 stores the measurement data acquired at step S36 (step S37).

Next, in a case where the upper system 200a does not need detailed information (step S38: No), the process ends.

On the other hand, in a case where the upper system 200a needs detailed information (step S38: Yes), the second transmission unit 111 transmits the measurement data stored at step S17 to the upper system 200a (step S39).

The determination process of step S38 will be described. In a case where demand-supply imbalance occurs against the power demand prediction on the current day of the power supply only under a certain system (for example, the aggregator), a faster DR may be processed by only the system. In such a case, the system does not need to transmit detailed measurement data that is additionally necessary for performing the faster DR to the upper system 200a. On the other hand, in a case where it is determined that the processing cannot be performed using only the system corresponding to the demand-supply imbalance, the upper system 200a performs the faster DR. In such a case, the upper system 200a needs the detailed measurement data that is additionally necessary for performing a faster DR, and accordingly, the detailed measurement data is transmitted to the upper system 200a. For this reason, in the case of a faster DR, the aggregation unit 110 does not aggregate the measurement data. In this way, the second transmission unit 111 can transmit the detailed measurement data to the upper system 200a more quickly.

Supplement of Information Processing Method

After the process of the flowchart illustrated in FIG. 5 described above, there are cases where the process of the flowchart of FIG. 6 is performed. In other words, the DR periods of the normal DR, the fast DR, and the faster DR overlap each other. For example, in a case where the information processing apparatus 20 used in the central power control center issues a normal DR 24 hours before the DR period, and it is determined that a target demand adjustment cannot be achieved due to an incorrect prediction of the weather or the temperature, there are cases where a faster DR is additionally issued.

In such cases, the information processing apparatus 10 use in the aggregator operates a DR request, which is received later, with priority. Hereinafter, a specific example will be described.

For example, the information processing apparatus 20 used in the central power control center creates a demand-supply plan of the whole system including performing a normal DR by building a power generation prediction of solar cells in the demand prediction. However, the weather forecast is incorrect, and power generation is performed using the solar cells less than expected, and the demand-supply imbalance occurs. In order to resolve the demand-supply imbalance, the information processing apparatus 20 used in the central power control center transmits a faster DR to the information processing apparatus 10 used in the aggregator. Each of the information processing apparatuses 10 used in the aggregator and the xEMS, in order to quickly perform a demand-supply adjustment, operates the storage battery 50 and the power generator 60 or immediately stops the devices 30 (for example, an air conditioner, a lamp, or the like), thereby reducing the amount of power consumption.

In addition, for example, the information processing apparatus 20 used in the central power control center creates a demand-supply plan of the whole system including performing a fast DR so as to satisfy the power generation plan of the previous day and the restrictions according to the topology of the transmission and distribution system. Then, the information processing apparatus 20 used in the central power control center transmits the fast DR to the information processing apparatus 10 used in the aggregator. Then, demand-supply imbalance occurs under a certain aggregator. Thus, the information processing apparatus 10 used in the aggregator transmits a faster DR to the information processing apparatus 10 used in the xEMS. The information processing apparatus 10 used in the aggregator performs a demand-supply simulation for an area managed by the information processing apparatus 10. At this time, in a case where the information processing apparatus 10 used in the aggregator manages bases that are physically distributed, there are cases where a demand-supply simulation may be performed only for some of the bases. In such cases, since the information processing apparatus 10 used in the aggregator can limit the range of the demand-supply simulation, the time required for the demand-supply simulation can be further shortened, and accordingly, a DR request or a control command can be transmitted more quickly.

### Second Embodiment

Next, a second embodiment will be described. In description of the second embodiment, description similar to that of the first embodiment will not be presented, and parts different from those according to the first embodiment will be described.

In the second embodiment, a case will be described in which, by executing a program on a demand-supply adjusting system 100 (see FIG. 1), in which a plurality of devices are arranged to be distributed, a DR request is created, and the DR request is distributed within the demand-supply adjusting system 100. In such a case, an application program used for a demand-supply adjustment using the DR request may be either software centrally executed by a central power control apparatus or software executed to be distributed at sites (the central power control apparatus, an aggregator, and an xEMS). The form in which the software is executed to be distributed at the sites is acquired by arranging information processing apparatuses 10 (20) each having a low calculation capability at the sites and has an advantage over the form in which the software is centrally executed by the central power control center that the cost of the whole demand-supply adjusting system 100 can be suppressed to be low.

Meanwhile, since the statuses of the execution of the program at the sites are not necessarily uniform, there is a possibility that accesses are concentrated on devices (information processing apparatuses 10a to 10f, an information processing apparatus 20, devices 30a to 30h, PVs 40a to 40c, storage batteries 50a to 50e, and power generators 60a and 60b) from the sites, and the execution of the software is blocked. Particularly, in the case of a faster DR of which the DR period is a short time, generally, while an area in which demand-supply imbalance occurs is limited, in order to respond to the demand-supply imbalance in a speedy manner, accesses from a plurality of sites to the devices arranged in the area may be easily concentrated.

In order to reliably implement a faster DR, it is necessary to respond to the access concentration. In the demand-supply adjusting system 100 according to the second embodiment, a case will be described in which an arbitration of an access to each device as a distributed application execution-based system is performed.

More specifically, in the demand-supply adjusting system 100 according to the second embodiment, parameters (for example, the power generation amount of the PV 40 and the remaining charged amount of the power generator 60) representing the states of power systems are automatically collected from remote places, a distributed application performing demand-supply management is presented, periods for collecting parameters of the power systems and times at which the latest statuses are collected are stored in association with each other, and the periods for collecting the parameters are changed in accordance with the frequencies of accesses to the parameters from the distributed application.

An example of the apparatus configuration of the demand-supply adjusting system 100 according to the second embodiment is the same as the apparatus configuration (see FIG. 1) of the demand-supply adjusting system 100 according to the first embodiment and will not be described. The functional configuration of the demand-supply adjusting system 100 according to the second embodiment will be described for the case of an information processing apparatus 10 used in the aggregator as an example.

Functional Configuration of Information Processing Apparatus Used in Aggregator

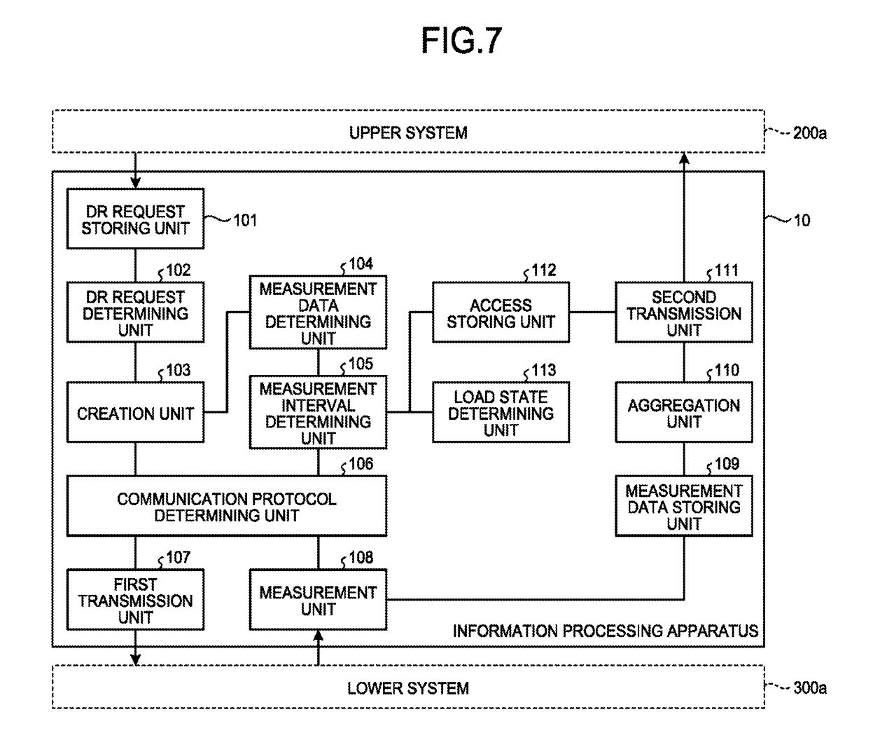

FIG. 7 is a diagram that illustrates an example of the functional configuration of the information processing apparatus used in the aggregator according to the second embodiment. The information processing apparatus 10 according to the second embodiment includes: a DR request storing unit 101; a DR request determining unit 102; a creation unit 103; a measurement data determining unit 104; a measurement interval determining unit 105; a communication protocol determining unit 106; a first transmission unit 107; a measurement unit 108; a measurement data storing unit 109; an aggregation unit 110; a second transmission unit 111; an access storing unit 112; and a load state determining unit 113. In other words, in the information processing apparatus 10 used in the aggregator according to the second embodiment, the access storing unit 112 and the load state determining unit 113 are added, which is different from the functional configuration of the information processing apparatus 10 used in the aggregator according to the first embodiment.

When an acquisition request of measurement data (parameter) is received from a measurement unit 108 of a upper system 200a, the second transmission unit 111 transmits measurement data stored in the measurement data storing unit 109 to the upper system 200a.

When the acquisition request of measurement data is received from the upper system 200a by the second transmission unit 111, the access storing unit 112 stores access information. The access information includes information (an IP address or the like) specifying a transmission source of the acquisition request of measurement data, information specifying requested measurement data, and reception time of the acquisition request of measurement data.

The load state determining unit 113 determines the load state of the own apparatus. The load state determining unit 113 determines the load state of the own apparatus, for example, by checking the use status of a CPU of the own apparatus. In addition, for example, the load state determining unit 113 determines the load state of the own apparatus by checking the access information stored in the access storing unit 112.

Measurement Based on Access Information

The measurement interval determining unit 105 determines a measurement interval of the measurement data based on the access information stored in the access storing unit 112. Basically, in a case where an interval at which certain measurement data is accessed is T, the measurement interval determining unit 105 sets an interval at which the measurement data is measured to T.

For example, an information processing apparatus 20 used in the central power control center is assumed to transmit an acquisition request of measurement data for the physical quantities (remaining charged amount) of a PV 40c to an information processing apparatus 10a used in the aggregator at an interval of ten minutes. In this case, the measurement interval determining unit 105 of the information processing apparatus 10a determines that the charged remaining amount of the PV 40c is measured at an interval of ten minutes.

The measurement unit 108 acquires measurement data by measuring the above-described physical quantities acquired from a lower system 300a or a control target 400 at the measurement interval determined by the measurement interval determining unit 105. The measurement data storing unit 109 stores the measurement data in the measurement data storing unit 109.

In this way, the demand-supply adjusting system 100 according to the second embodiment can return new measurement data for each acquisition request of measurement data while suppressing the load of accesses to the lower system 300a and the control target 400.

Distribution of Access Load

The demand-supply adjusting system 100 according to the second embodiment is a distributed application performing demand-supply management while distributing an access load at the time of collecting a parameter (measurement data) representing a power system state.

In a case where a plurality of information processing apparatuses 10 (20) access an information processing apparatus 10 storing certain measurement data at a high frequency, the load is concentrated on the information processing apparatus 10. In addition, in a case where a plurality of information processing apparatuses 10 (20) access a control target 400 using certain physical quantities (a voltage, a frequency, and the like) at a high frequency, the load is concentrated on the control target 400.

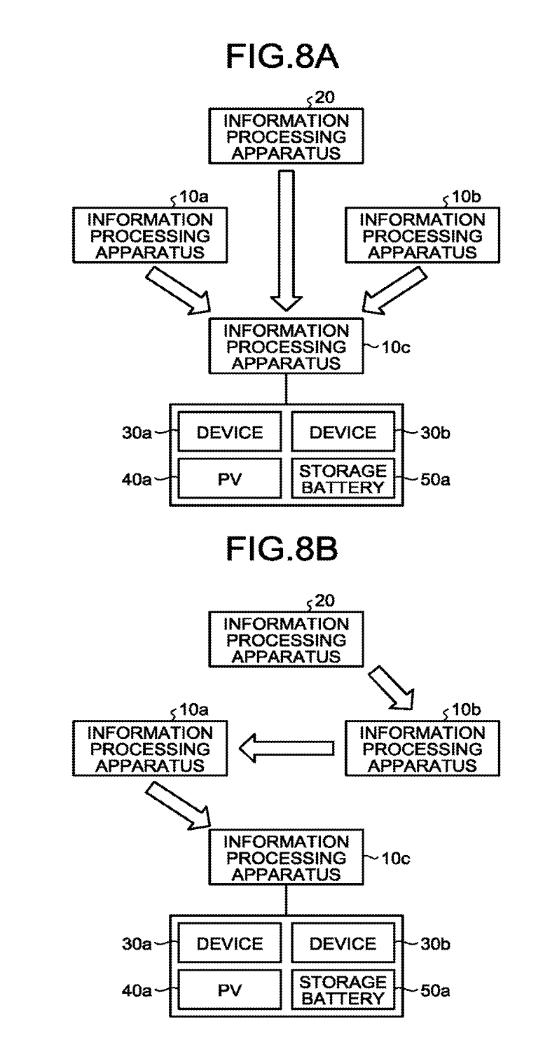

FIG. 8A is a diagram that illustrates an example of a case where an access load is concentrated. The example illustrated in FIG. 8A illustrates a case where acquisition requests of measurement data from information processing apparatuses 10a and 10b used in the aggregator and an information processing apparatus 20 used in the central power control center are concentrated on an information processing apparatus 10c used in the xEMS, and accordingly, the access load is concentrated on the information processing apparatus 10c.

In the demand-supply adjusting system 100 according to the second embodiment, the access load is distributed as illustrated in FIG. 8B.

FIG. 8B is a diagram that illustrates an example of a case where the access load is distributed according to the second embodiment. The example of FIG. 8B illustrates a case where the information processing apparatus 10a used in the aggregator accesses the measurement data stored in the information processing apparatus 10c used in the xEMS. As illustrated in FIG. 8B, the information processing apparatus 10a acquires the measurement data from the information processing apparatus 10c. The information processing apparatus 10b acquires the measurement data stored in the information processing apparatus 10c from the information processing apparatus 10a. Then, the information processing apparatus 20 acquires the measurement data stored in the information processing apparatus 10c from the information processing apparatus 10b. In this way, the access load for the information processing apparatus 10c can be distributed.

A supervisor of each information processing apparatus 10 (20) monitors the load of the information processing apparatus 10 (20) and appropriately changes the access destination, which consumes time and labor. Accordingly, in the demand-supply adjusting system 100 according to the second embodiment, the information processing apparatuses 10 (20) change access paths from the state illustrated in FIG. 8A to the state illustrated in FIG. 8B in cooperation with each other.

More specifically, the load state determining unit 113 of each information processing apparatus 10 (20) determines whether the load of the own apparatus is equal to or larger than a threshold (third threshold), and the number of apparatuses that transmit acquisition requests of measurement data to the own apparatus is equal to or more than a threshold (fourth threshold).

In a case where the load of the own apparatus is equal to or larger than the third threshold, and the number of apparatuses that transmit acquisition requests of measurement data to the own apparatus is equal to or more than the fourth threshold, the second transmission unit 111 specifies an information processing apparatus 10 (20) that has already acquired the measurement data based on the access information stored in the access storing unit 112. Then, the second transmission unit 111 notifies information specifying the information processing apparatus 10 (20) that has already acquired the measurement data to some of the information processing apparatuses 10 (20).

Hereinafter, the process performed in a case where the access paths are changed from the state illustrated in FIG. 8A to the state illustrated in FIG. 8B will be described for a case where a faster DR is transmitted from the information processing apparatus 20 used in the central power control center to the information processing apparatus 10 used in the aggregator as an example.

(1) After a faster DR is transmitted, the information processing apparatuses 10a, 10b, and 20 transmit acquisition requests of measurement data to the information processing apparatus 10c (see FIG. 8A).

(2) The access storing unit 112 of the information processing apparatus 10c stores access information of each of the information processing apparatuses 10a, 10b, and 20.

(3) The load state determining unit 113 of the information processing apparatus 10c recognises that the access load of the own apparatus is high based on the access information.

(4) The load state determining unit 113 of the information processing apparatus 10c determines the information processing apparatus 10a among the information processing apparatuses 10a, 10b, and 20 as an apparatus that can access the own apparatus. A method of determining an accessible apparatus, for example, is based on communication time with the own apparatus, a communication amount with the own apparatus, a prior agreement, and the like.

(5) The second transmission unit 111 of the information processing apparatus 10c transmits change notifications representing a change in the acquisition destination of the measurement data to the information processing apparatuses 10b and 20.

(6) When the change notification is received from the information processing apparatus 10c, the information processing apparatus 10b changes the transmission destination of the acquisition request of measurement data from the information processing apparatus 10c to the information processing apparatus 10a in accordance with the change notification.

(7) When the change notification is received from the information processing apparatus 10c, the information processing apparatus 20 changes the transmission destination of the acquisition requests of measurement data from the information processing apparatus 10c to the information processing apparatus 10b in accordance with the change notification.

The demand-supply adjusting system 100 according to the second embodiment changes the access paths from the state illustrates in FIG. 8A to the state illustrated in FIG. 8B by performing the processes of (1) to (7) described above. This access path state is continued until the load state of one of the information processing apparatuses 10 (20) is changed, or a faster DR ends.

In the example described above, while a case has been described in which the number of transmission apparatuses that transmit acquisition requests of measurement data is three (the information processing apparatuses 10a, 10b, and 20), the number of transmission apparatuses that transmit the acquisition requests of measurement data may be arbitrary (N). When the number of transmission apparatuses is N, in a case where the load of the own apparatus is equal to or larger than the third threshold, and the number N of transmission apparatuses that transmit acquisition requests of measurement data to the own apparatus is equal to or more than the fourth threshold, the second transmission unit 111 determines a first acquisition apparatus acquiring measurement data from the own apparatus and a (k+1)-th acquisition apparatus acquiring measurement data from a k-th (here, 1≦k≦N−1) acquisition apparatus from among the N transmission apparatuses. Then, the second transmission unit 111 notifies the determined acquisition destinations of the measurement data to the N transmission apparatuses.

As described above, according to the demand-supply adjusting system 100 of the second embodiment, the concentration of the load on one apparatus can be prevented.

Finally, an example of the hardware configuration of the information processing apparatuses 10 (20) according to the first and second embodiments will be described.

Hardware Configuration of Information Processing Apparatus

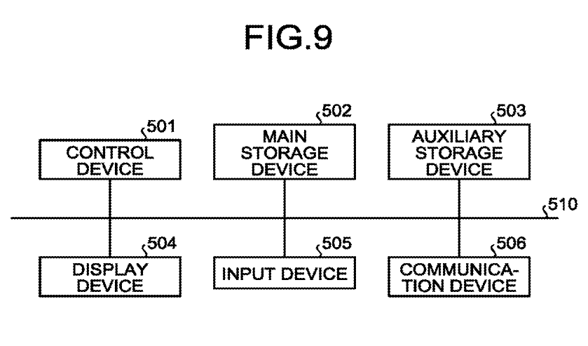

FIG. 9 is a diagram that illustrates an example the hardware configuration of the information processing apparatuses 10 (20) according to the first and second embodiments.

Each of the information processing apparatuses 10 (20) according to the first and second embodiments includes: a control device 501; a main storage device 502; an auxiliary storage device 503; a display device 504; an input device 505; and a communication device 506. The control device 501, the main storage device 502, the auxiliary storage device 503, the display device 504, the input device 505, and the communication device 506 are interconnected through a bus 510.

The control device 501 executes a program read from the auxiliary storage device 503 into the main storage device 502. The control device 501, for example, is a CPU. The main storage device 502 is a memory such as a read only memory (ROM), a random access memory (RAM), or the like. The auxiliary storage device 503 is a memory card, a hard disk drive (HDD), or the like.

The display device 504 displays information. The display device 504, for example, is a liquid crystal display. The input device 505 receives input of information. The input device 505, for example, is a keyboard, a mouse, or the like. In addition, the display device 504 and the input device 505 may be a liquid crystal touch panel that has both a display function and an input function. The communication device 506 communicates with other devices.

Each of the programs executed by the information processing apparatuses 10 (20) according to the first and second embodiments is recorded on a computer-readable recording medium such as a CD-ROM, a memory card, a CD-R, and a digital versatile disk (DVD) as a file of an installable form or an executable form and is provided as a computer program product.

In addition, each of the programs executed by the information processing apparatuses 10 (20) according to the first and second embodiments may be configured to be stored on a computer connected to a network such as the Internet and be provided by being downloaded through the network. Furthermore, each of the programs executed by the information processing apparatuses 10 (20) according to the first and second embodiments may be configured not to be downloaded but to be provided through a network such as the Internet.

In addition, each of the programs executed by the information processing apparatuses 10 (20) according to the first and second embodiments may be configured to be built in a ROM or the like in advance and then, provided.

Each of the programs executed by the information processing apparatuses 10 (20) according to the first and second embodiments has a module configuration including functions that can be implemented by a program among the functional configurations of each of the information processing apparatuses 10 (20) according to the first and second embodiments.

As the control device 501 reads a program from a storage medium such as the auxiliary storage device 503 and executes the read program, the function implemented by the program is loaded into the main storage device 502. In other words, the function implemented by the program is generated on the main storage device 502.

In addition, a part of the functions of the information processing apparatuses 10 (20) according to the first and second embodiments may be implemented by hardware such as an integrated circuit (IC).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying and their equivalents are intended to cover such forms or modifications as would fall within the scope and spirit of the inventions.

What is claimed is:

1. An information processing apparatus comprising:
a creation unit configured to create a demand-supply adjustment plan of electric power in accordance with a type of first demand response request received from an upper system and create a second demand response request based on the demand-supply adjustment plan;
a measurement data determining unit configured to determine measurement data of a measurement target in accordance with a type of the second demand response request;
a measurement interval determining unit configured to determine a measurement interval of the measurement data in accordance with the type of second demand response request;
a communication protocol determining unit configured to determine a communication protocol used for transmitting the second demand response request in accordance with the type of the second demand response request;
a first transmission unit configured to transmit the second demand response request to a lower system by using the communication protocol;
a measurement unit configured to measure the measurement data based on the measurement data, the measurement interval, and the communication protocol; and
a second transmission unit configured to transmit the measurement data to the upper system.

2. The information processing apparatus according to claim 1, wherein the first transmission unit transmits a control command of power consumed by a device that is a control target of the information processing apparatus to the device based on the demand-supply adjustment plan.

3. The information processing apparatus according to claim 1, wherein the first transmission unit transmits a control command of power supplied by a power supply device that is a control target of the information processing apparatus to the power supply device based on the demand-supply adjustment plan.

4. The information processing apparatus according to claim 1, further comprising an aggregation unit configured to aggregate the measurement data when a grace period is equal to or longer than a first threshold and a time until the measurement data arrives at the upper system from the information processing apparatus is shorter in a case where the measurement data is aggregated than in a case where the measurement data is not aggregated, the grace period being a period until a demand adjustment of power during a period designated in the first demand response request is started after transmission of the first demand response request, wherein
in a case where the measurement data is aggregated, the second transmission unit transmits the aggregated measurement data to the upper system.

5. The information processing apparatus according to claim 1, wherein, when the grace period is equal to or shorter than a second threshold, the second transmission unit transmits the measurement data to a transmission source of the first DR request not through another information processing apparatus.

6. The information processing apparatus according to claim 1, wherein the creation unit performs a demand-supply simulation of power and creates the demand-supply adjustment plan based on the demand-supply simulation.

7. The information processing apparatus according to claim 6, wherein the creation unit changes a target range of the demand-supply simulation and the measurement data used in the demand-supply simulation in accordance with the type of the first demand response request.

8. The information processing apparatus according to claim 1, further comprising a demand response request determining unit configured to determine the type of the first demand response request.

9. The information processing apparatus according to claim 1, further comprising an access storing unit configured to store therein access information when an acquisition request of the measurement data is received from the upper system, the access information including information for specifying a transmission source of the acquisition request of measurement data, information for specifying requested measurement data, and reception time of the acquisition request of measurement data, wherein
the measurement interval determining unit determines the measurement interval of the measurement data based on the access information.

10. The information processing apparatus according to claim 1, wherein, when a load of the information processing apparatus is equal to or larger than a third threshold, and the number N of transmission apparatuses that transmit acquisition requests of measurement data to the information processing apparatus is equal to or more than a fourth threshold, the second transmission unit determines, from among the N transmission apparatuses, a first acquisition apparatus that acquires measurement data from the information processing apparatus and a (k+1)-th acquisition apparatus that acquires measurement data from a k-th (1≦k≦N−1) acquisition apparatus and notifies the determined acquisition apparatuses to the N transmission apparatuses.

11. An information processing method comprising:
creating a demand-supply adjustment plan of electric power in accordance with a type of first demand response request received from an upper system;
creating a second DR request based on the demand-supply adjustment plan;
determining measurement data of a measurement target in accordance with a type of the second demand response request;
determining a measurement interval of the measurement data in accordance with the type of second demand response request;
determining a communication protocol used for transmitting the second demand response request in accordance with the type of the second demand response request;
transmitting the second demand response request to a lower system by using the communication protocol;
measuring the measurement data based on the measurement data, the measurement interval, and the communication protocol; and
transmitting the measurement data to the upper system.

12. A computer program product comprising a non-transitory computer-readable medium containing a computer program that causes a computer to function as:
a creation unit configured to create a demand-supply adjustment plan of electric power in accordance with a type of first demand response request received from an upper system and create a second demand response request based on the demand-supply adjustment plan;
a measurement data determining unit configured to determine measurement data of a measurement target in accordance with a type of the second demand response request;
a measurement interval determining unit configured to determine a measurement interval of the measurement data in accordance with the type of second demand response request;
a communication protocol determining unit configured to determine a communication protocol used for transmitting the second demand response request in accordance with the type of the second demand response request;
a first transmission unit configured to transmit the second demand response request to a lower system by using the communication protocol;
a measurement unit configured to measure the measurement data based on the measurement data, the measurement interval, and the communication protocol; and
a second transmission unit configured to transmit the measurement data to the upper system.
